(19) United States
(12) Patent Application Publication
(10) Pub. No.: US 2006/0077673 A1
(43) Pub. Date: Apr. 13, 2006

(54) Means to increase the light output by the illuminator in a LCoS based light engine

(76) Inventors: Arthur Berman, San Jose, CA (US); Ying-Moh Liu, Saratoga, CA (US); Glenn Wheelock, San Jose, CA (US); John Walter Carpenter, Castro Valley, CA (US)

Correspondence Address: REED SMITH, LLP, TWO EMBARCADERO CENTER, SUITE 2000, SAN FRANCISCO, CA, 94111, US

(21) Appl. No.: 10/961,169

(22) Filed: Oct. 8, 2004

(51) Int. Cl. B60Q 1/124

(52) U.S. Cl. 362/458; 313/483; 362/84

(57) ABSTRACT

A phosphor layer is positioned to absorb UV light and re-radiate usable light in other wavelengths. The UV light is reflected to the phosphor by a thin film placed in a light path. The phosphor re-radiates the usable light in a direction of the light path. Curved mirrors or directive reflectors are utilized to direct some of the re-radiated light toward the light path. In one embodiment, usable light in the light path is reflected by a thin film, UV light is passed by the thin film toward the phosphor, and the re-radiated light is directed toward the reflected visible light path.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of Invention

The invention relates to illumination devices, and more particularly, illumination devices used in image projection systems.

2. Discussion of Background

The projection mechanism within a LCOS microdisplay based video projector is called a light engine. FIG. 1 illustrates a generic version of one of the many possible light engine configurations. The light source is typically a mercury short arc lamp. Note that this type light source outputs a great deal of ultra violet light. Since exposure to UV light can degrade microdisplays, one function of the illuminator is to filter out the UV.

### SUMMARY OF THE INVENTION

The present inventors have realized the need for an illuminator with increased output of useful light. The inventions disclosed in this document are techniques and apparatuses to increase the light output by an illuminator. More specifically, the inventions are based on the inclusion of a phosphor into the optical path of an illuminator for the purpose of converting unused ultra violet light into useable visible light.

The invention integrates of a phosphor (or other material capable of converting undesirable light wavelengths into usable wavelengths) into the illuminator for the purpose of converting less desirable light into useable light (e.g., converting ultra violet light into visible light). The invention is preferably utilized in a light engine of an LCOS based video projector. But may also be utilized in Digital Light Processing (DLP) (e.g., displays using micro-mirror technology), High Temperature Polysilicon HTPL (e.g., displays using liquid crystal technologies), or any other device that requires an illuminator.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a drawing of a conventional illuminator in an LCOS based image projection system;

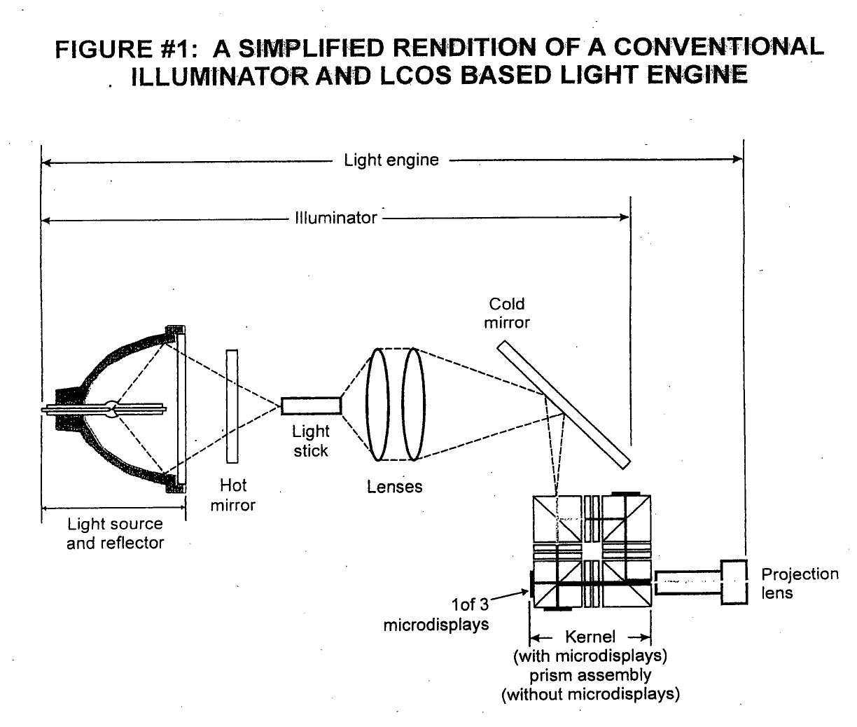

FIG. 2 is a drawing of an illuminator having a UV reflector and phosphor layer according to an embodiment of the present invention; and

FIG. 3 is a drawing of an illuminator having a UV pass/visible light reflector and a phosphor layer according to an embodiment of the present invention.

### DESCRIPTION OF THE PREFERRED EMBODIMENTS

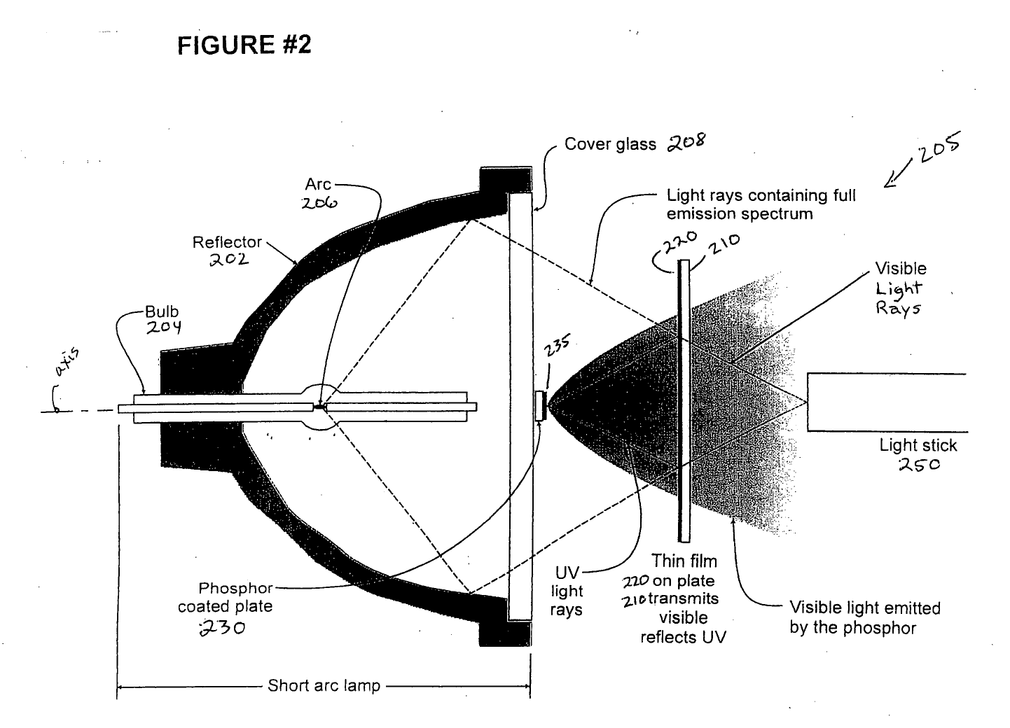

FIG. 2 illustrates the first of the disclosed new illuminator configurations. The illustration is simplified in the sense that only relevant and innovative components are included in the figure. Other required but more conventional components such as filters and lenses are not necessarily included in the figure. The principle of operation of the new illuminator 205 is as follows:
Light from the short arc lamp directed by reflector 202 is intercepted by a plate 210 that is coated with a thin film 220. The thin film 220 transmits visible light and reflects UV light. The thin film 220 is, for example, a commercially available film constructed from multiple layers of material, each layer alternating between high and low indexes of refraction. A central ray in the light ray bundle intercepted by the plate is incident perpendicular to the plate.
Visible light is transmitted through the plate 210 and goes on to enter the end of the light stick 250.
UV light is reflected on to a small plate 230 located on the front of a lamp cover glass 208 (or other frame used to secure the small plate). The small plate 230 is coated with a phosphor 235 that absorbs UV light and re-radiates visible light. Phosphors are available with high conversion efficiency and can be constructed to reradiate any desired portion of the visible spectrum. Locating the small phosphor plate along an axis of the bulb results in little, if any illuminator light loss since the plate is in a “shadow” of the bulb.
Preferably, the re-radiation wavelength of the phosphor is chosen to increase underrepresented wavelengths in light output from the illuminator. Although blue light is prevalent in the spectra of the Arc light source, glass and other components of the illuminator and a light engine or other system in which the illuminator may be utilized will generally absorb or be less efficient with blue light compared to other wavelengths (glass absorption, microdisplay reflectivity efficiency, etc.), effectively causing blue light to be underrepresented. Therefore, additional blue light may be desirable, and a phosphor layer is chosen to re-radiate blue wavelength light.
Other systems in which the illuminator may be utilized may have a need for increased representation in wavelengths other than blue, and the re-radiation properties of the phosphor layer is chosen according to that need. In one embodiment, the phosphor layer re-radiates light in more than one portion of the light spectrum, and the phosphor layer is, for example, composed of multiple phosphors having different properties.
The phosphor re-radiates light in many directions, including toward the light stick 250. In one embodiment, the plate on which the phosphor layer is located in a transparent material and light re-radiated from the phosphor toward the reflector 202 passes through the plate and into the reflector 202. In another embodiment, the small plate 230 has a mirror backing to reflect any of the re-radiated light directed toward the bulb in a direction back through the phosphor layer and toward the light stick 250. In yet another embodiment, a directive mirror (e.g. curved mirror) is placed behind the phosphor layer to re-direct as much as possible of the re-radiated light toward the light stick 250.
Although the small plate 230 is located in a “shadow” of the bulb, some spurious light rays may illuminate the “shadow.” Other types or designs of bulbs have more or less light rays entering the shadow. In one embodiment, the small plate includes a reflective coating on the back side of the plate (e.g., side of the plate closest to the bulb 204) to reflect light rays entering the shadow and impacting the back side of the small plate back into the reflector 202.
Some portion of the visible light emitted by the phosphor enters the end of the light stick 250 (or other output or light collection point) within an angular range that allows it to contribute to illumination of a device (e.g., a kernel or light management system) using the illuminator.

Note that the inclusion of UV conversion components into the illuminator is not incompatible with the incorporation of polarization conversion optics that may be needed for other aspects of a design using the illuminator.

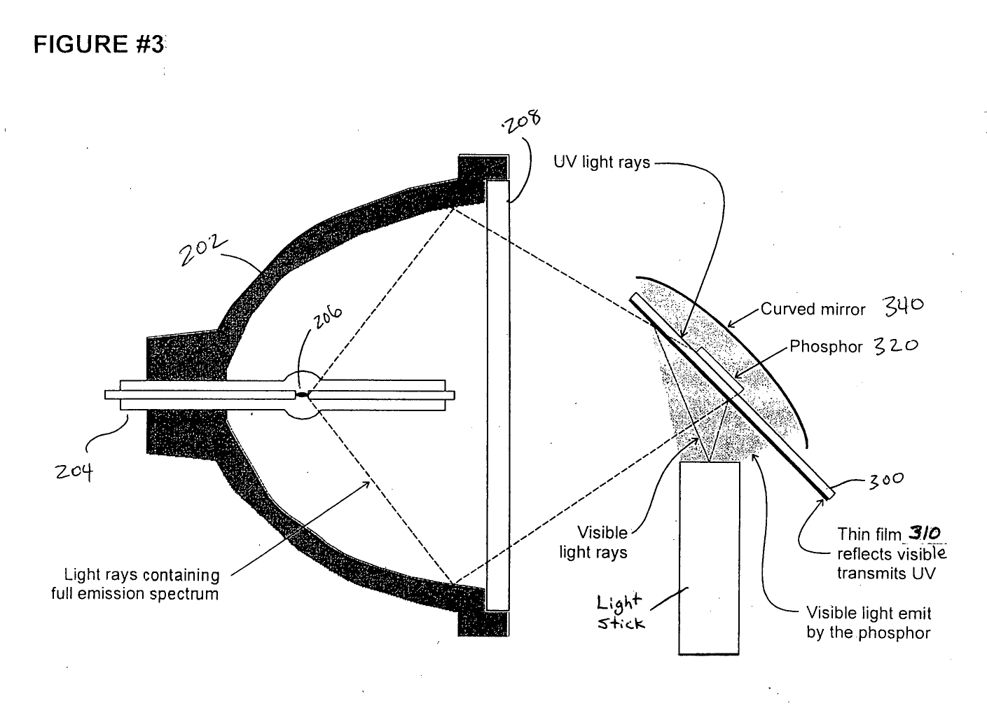

A second new illuminator 305 is illustrated in FIG. 3. The principle of operation of illuminator 305 is as follows:
Light directed by the reflector 202 from the short arc lamp 206 is intercepted by a plate 300 the front surface of which is coated with a thin film 310 that reflects visible light and transmits UV light. A central ray in the light bundle intercepted by the plate 300 is incident at an angle of 45° to the plate (e.g., the plate may be, for example, a 45° cold mirror).
The reflected visible light goes on to enter the end of the light stick (or other collection point of the illuminator).
UV light travels through the thin film 310 on the front surface of the plate 300 and impacts a layer of phosphor 320 on the rear surface of the plate.
The phosphor layer 320 re-radiates visible light. The re-radiated light is collected by a curved mirror 330 and focused back through the plate onto the end of the light stick. A portion of this light will contribute to illumination of the kernel.
Note that some of the re-radiated light reflected from the curved mirror will intersect the phosphor. Since this portion is more likely to be lost (although some portion may be reflected or potentially passed through the phosphor layer), the design of the system geometry preferably minimizes the phosphor-coated area.

As before, the inclusion of UV conversion components into the illuminator is not incompatible with the incorporation of polarization conversion optics.

Although the present invention has been described herein with reference to single channel arc bulb type illuminators, it should be apparent upon review of the present disclosure that the devices and processes of the present invention may be applied to other illuminator type devices including multiple channel illuminators including, but not limited to, illuminators using more than one light source and/or more than one main reflector, and that the illuminator may be used for any purpose where light is needed.

In describing the embodiments of the present invention, specific terminology is employed for the sake of clarity. However, the present invention is not limited to the specific terminology so selected, and it is to be understood that each specific element includes all technical equivalents which operate in a similar manner. For example, when describing UV reflective or passing materials, the invention is not limited to materials prepared by a single manufacture, constructed in only the described manner (unless specifically described as such in the appended claims), but instead should be considered with respect to any optical component or device capable producing a desired result similar to that described herein. The thin films described herein may be, for example, any optical device that either passes UV and reflects visible light or reflects UV and passes visible light according to the specific embodiment design. And, adjustments or modifications (whether or not specifically discussed) to the designs presented herein may be made to utilize materials having different properties, but still fall within the spirit, scope, and intent of the present invention. Listing all the possible combinations of components to do so would be voluminous and not add significant pertinent disclosure.

Accordingly, all described items, including, but not limited to thin films, reflective coatings, mirrors, bulbs, phosphors, etc should also be consider in light of any and all available equivalents. Furthermore, the inventors recognize that newly developed technologies not now known may also be substituted for the described parts and still not depart from the scope of the present invention.

Obviously, numerous modifications and variations of the present invention are possible in light of the above teachings. It is therefore to be understood that within the scope of claims to be appended upon filing of a utility patent application, the invention may be practiced otherwise than as specifically described herein.

What is claimed and desired to be secured by Letters Patent of the United States is:

1. An illuminator, comprising:
a UV reflector having properties that reflect light in UV wavelengths and passes light in other wavelengths; and
a phosphor layer in a path of the UV reflected light.

2. The illuminator according to claim 1, wherein said phosphor layer is positioned to intercept and absorb UV light reflected from the UV reflector and re-radiate visible light in a general direction of light passed by the UV reflector.

3. The illuminator according to claim 1, further comprising a light source configured to direct light toward the UV reflector;
wherein said phosphor layer is positioned to absorb UV light reflected from the UV reflector and re-radiate visible light in a general direction of light passed by the UV reflector.

4. The illuminator according to claim 1, further comprising a light source and a source reflector configured to direct light from the light source toward the UV reflector;
wherein the phosphor layer is positioned in a path of UV light reflected from the UV reflector.

5. The illuminator according to claim 1, wherein a central light ray emanating from the light source and light reflector is perpendicularly incident to the UV reflector.

6. The illuminator according to claim 4, wherein the phosphor layer is positioned in a shadow of the light source.

7. The illuminator according to claim 4, wherein the phosphor layer is located between the UV reflector and the light source.

8. The illuminator according to claim 4, wherein the phosphor layer is deposited on a plate having a surface configured to direct the re-radiated light in a same direction as light passed by the UV reflector.

9. The illuminator according to claim 8, wherein the plate surface is curved.

10. The illuminator according to claim 8, further comprising a light stick;
wherein visible light emanating from the light source is directed by the source reflector and passed through the UV reflector toward the light stick; and
visible light re-radiated from the phosphor layer is directed by an orientation of the phosphor on the plate toward the light stick.

11. An illuminator, comprising:
a light source;
a source reflector configured to direct light emanating from the light source in a path toward a target position;
a UV sensitive layer positioned in the path; and
a phosphor layer positioned to absorb light from the light source.

12. The illuminator according to claim 1, wherein the UV sensitive ayer comprises a thin layer that is reflective of UV light and passes visible light.

13. The illuminator according to claim 1, wherein the UV sensitive layer comprises a thin layer that passes UV light and reflects visible light.

14. The illuminator according to claim 3, wherein:
the phosphor layer is located at the target position; and
the UV sensitive layer is positioned between the light source and the phosphor layer.

15. The illuminator according to claim 4, further comprising a second reflector positioned to reflect at least light re-radiated from the phosphor layer.

16. The illuminator according to claim 5, wherein light reflected off the second reflector is reflected in a direction similar to the visible light reflected from the UV sensitive layer.

17. The illuminator according to claim 2, wherein:
the phosphor layer is positioned to absorb UV light from the light source that has been reflected off the UV sensitive layer; and
the phosphor layer is configured to re-radiate visible light toward the target position.

18. The illuminator according to claim 7, wherein the target position is a visible light collection port.

19. An illuminator comprising:
a light source;
a phosphor layer positioned to absorb only UV light from the light source and re-radiate visible light.

20. The illuminator according to claim 9, wherein the phosphor layer re-radiates visible light in a same direction as visible light from the light source.

21. The illuminator according to claim 9, further comprising a reflector configured to direct re-radiated visible light from the phosphor layer to a light path of the light source.
